(19) United States
(12) Patent Application Publication
(10) Pub. No.: US 2020/0004366 A1
(43) Pub. Date: Jan. 2, 2020

(54) TOUCH DISPLAY PANEL WITH INTEGRAL FINGERPRINT SENSOR AND ELECTRONIC DEVICE USING SAME

(71) Applicant: HON HAI PRECISION INDUSTRY CO., LTD., New Taipei (TW)

(72) Inventors: YU-FU WENG, New Taipei (TW); CHIEN-WEN LIN, New Taipei (TW); CHIA-LIN LIU, New Taipei (TW); TZU-YU CHENG, New Taipei (TW)

(21) Appl. No.: 16/452,919

(22) Filed: Jun. 26, 2019

(30) Foreign Application Priority Data
Jun. 27, 2018 (CN) 201810685890.2

(51) Int. Cl. G06F 3/041; G06K 9/00; G06F 1/16; G06F 3/047

(52) U.S. Cl. CPC G06F 3/0412; G06F 3/047; G06F 1/1643; G06K 9/00087

(57) ABSTRACT

A touch display panel which includes an integral fingerprint recognition portion also comprises a central processor, a switch module, and a main touch portion. The fingerprint recognition portion comprises fingerprint recognition electrodes connected to the central processor. The main touch portion comprises touch electrodes to sense touches. At least one touch electrode is electrically connected to one fingerprint recognition electrode through the switch module, and the switch module is controlled by the processor to cycle through connected or disconnected states between the touch electrode and the fingerprint recognition electrode.

### FIELD

The subject matter relates to touch screens.

### BACKGROUND

Electronic devices, such as mobile phones, can include fingerprint recognition modules. The existing fingerprint recognition module is independent from the touch display panel, and an additional fingerprint recognition module needs to be installed when the mobile phone is assembled. The touch display panel may comprise a switch module positioned outside the touch display panel. The switch module may only be used in a quality test stage after the panel is manufactured, and the switch module may not used after the panel is assembled. This approach and layout may not be the most efficient use of space.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a schematic diagram of a touch display panel according to a first embodiment of the present disclosure.

FIG. 2 is a cross-sectional view along a line II-II of FIG. 1.

FIG. 3 is an enlarged view of a part of a fingerprint recognition unit of the touch display panel of FIG. 1.

FIG. 4 is a schematic diagram of a part of the touch display panel of FIG. 1.

FIG. 5 is a schematic diagram of the touch display panel according to a second embodiment of the present disclosure.

FIG. 6 is a schematic diagram of the touch display panel according to a third embodiment of the present disclosure.

FIG. 7 is a schematic diagram of the touch display panel according to a fourth embodiment of the present disclosure.

FIG. 8 is an enlarged schematic diagram of a part of the touch display panel of FIG. 7.

FIG. 9 is a schematic diagram of an electronic device including the touch display panel of the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

### FIRST EMBODIMENT

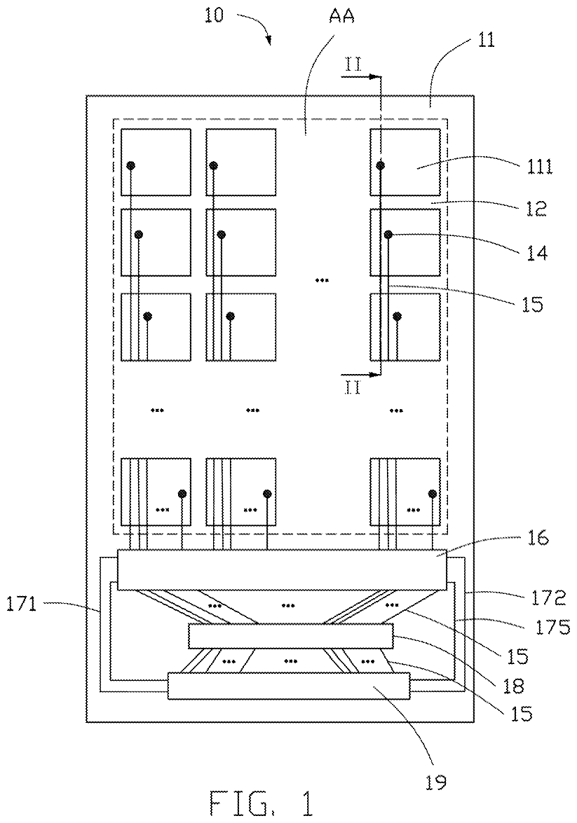

FIG. 1 shows a touch display panel 10 according to a first embodiment of the present disclosure. The touch display panel 10 includes a thin film transistor (TFT) array substrate 11. The touch display panel 10 further includes a switch module 16, a fingerprint recognition portion 18, and a central processor 19 positioned on the TFT array substrate 11. The switch module 16, the fingerprint recognition portion 18, and the central processor 19 are adjacent to one end of the TFT array substrate 11. The fingerprint recognition portion 18 is electrically connected to the switch module 16 and the central processor 19.

The touch display panel 10 further includes a display area (labeled “AA”) for displaying images. The switch module 16, the fingerprint recognition portion 18, and the central processor 19 are located outside the display area AA. The fingerprint recognition portion 18 can sense a fingerprint presented to the fingerprint recognition portion 18.

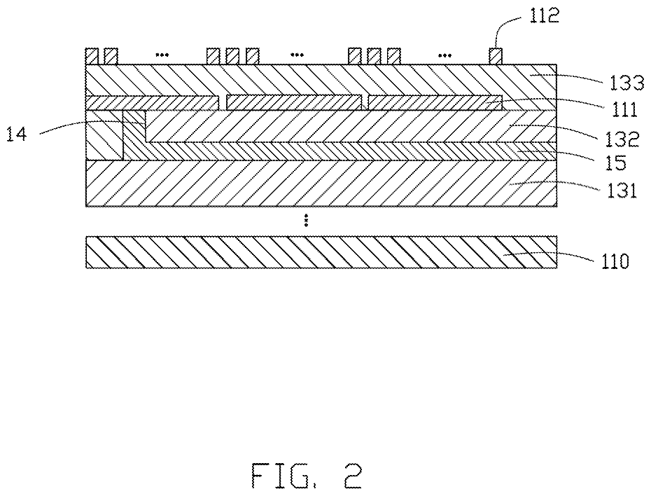

With reference to FIG. 2, the TFT array substrate 11 further includes a glass substrate 110, a plurality of touch electrodes 111, a plurality of pixel electrodes 112, a passivation film 13, and a trace layer 15. The passivation film 13 includes a first passivation layer 131, a second passivation layer 132, and a third passivation layer 133. The first passivation layer 131 is formed on the glass substrate 110. The trace layer 15 is formed on a surface of the first passivation layer 131 facing away from the glass substrate 110. The trace layer 15 includes patterned traces that can be formed by etching a layer of conductive material. The second passivation layer 132 is formed on a surface of the first passivation layer 131 facing away from the glass substrate 110, and covers the trace layer 15. The second passivation layer 132 defines a plurality of holes or vias 14. The patterned traces of the trace layer 15 passes through the vias 14, and are exposed from the second passivation layer 132.

The touch electrodes 111 are formed on a surface of the second passivation layer 132 facing away from the first passivation layer 131. The touch electrodes 111 are arranged in a matrix. Each touch electrodes 111 corresponds to one via 14, and is electrically connected to the exposed patterned trace received in the via 14. Each touch electrode 111 is further electrically connected to the switch module 16 through the trace layer 15. The touch electrodes 111 define a main touch portion 12. The main touch portion 12 is a single-layered and self-capacitance electrode structure. The main touch portion 12 is located in the display area AA. The main touch portion 12 can sense a touch position performed on the display area AA through the touch electrodes 111.

The third passivation layer 133 is formed on a surface of the second passivation layer 132 facing away from the first passivation layer 131, and covers the touch electrodes 111. The pixel electrodes 112 are formed on a surface of the third passivation layer 133 facing away from the touch electrodes 111. The pixel electrodes 111 are arranged in a matrix. The touch electrodes 111 can be common electrodes. The pixel electrodes 112 and the touch electrodes 111 cooperatively rotate the liquid crystal molecules in the liquid crystal layer, and the liquid crystal layer being outside the TFT array substrate 11.

In one embodiment, the touch electrodes 111 have the same surface area, and the touch electrode 111 can be in the shape of a square with a length of a side from about 3 mm to 5 mm. In other embodiments, the surface areas and the shapes of the touch electrodes 111 may be different from each other, and the surface areas of a portion of the touch electrodes 111 near the edge of the TFT array substrate 11 can be smaller than other portions of the touch electrodes 111.

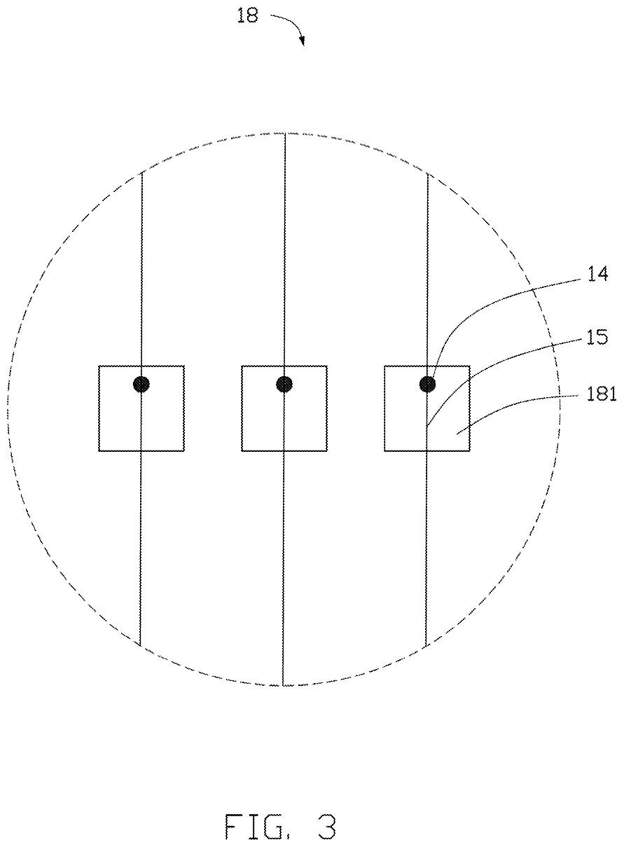

The fingerprint recognition portion 18 is a single-layered and self-capacitance electrode structure. With reference to FIG. 3, the fingerprint recognition portion 18 includes a plurality of fingerprint recognition electrodes 181 spaced apart from each other. The fingerprint recognition electrodes 181 and the touch electrodes 11 can be formed by a single photolithography process. The switch module 16 is electrically connected to the fingerprint recognition electrodes 181 through the trace layer 15. The trace layer 15 that is connected to the fingerprint recognition electrodes 181 is further extended along the via 14 to the central processor 19. The trace layer 15 is electrically connected to the central processor 19.

The surface area of the fingerprint recognition portion 18 is less than or equal to one hundredth of the surface area of the main touch portion 12. The surface area of each fingerprint recognition electrode 181 is less than or equal to one hundredth of the surface area of each touch electrode 111. In one embodiment, each fingerprint recognition electrode 181 has the same shape and surface area. The fingerprint recognition electrodes 181 are square in the present embodiment. A length of fingerprint recognition electrodes 181 is about 30 μm to 50 μm. Each touch electrode 111 has same shape and area. The Average distance between adjacent fingerprint recognition electrodes 181 is not more than the maximum width of the fingerprint recognition electrode 181. In other embodiments, both the surface area and shape of each fingerprint recognition electrode 181 may be different.

There are peaks and valleys of an the human finger, the peaks and valleys on the surface of the human finger. The Average distance between adjacent peaks for an adult ranges from about 0.2 mm to 0.5 mm. The Average distance between adjacent peaks for a child is about 0.1 mm apart. The maximum width of one single fingerprint recognition electrode 181 in the present embodiment is much smaller than the Average distance between adjacent peaks of the human finger. The fingerprint recognition portion 18 can effectively acquire the information of the peak and valley according to the capacitance change of the fingerprint recognition electrodes 181. When a finger touches the fingerprint recognition portion 18, the skin of the human finger at the peaks are in contact with the fingerprint recognition portion 18. The capacitances of the fingerprint recognition electrodes 181 will change and enable the fingerprint recognition. The skin of the human finger at the valleys do not make contact with the fingerprint recognition portion 18, thus causing no change or very little change in capacitances of the fingerprint recognition electrodes 181. The number of fingerprint recognition electrodes 181 may be less than or equal to the number of touch electrodes 111. In the present, the number of fingerprint recognition electrodes 181 may be equal to the number of touch electrodes 111.

In one embodiment, the fingerprint recognition portion 18 is a rectangle. The length of the fingerprint recognition portion 18 is not more than 3 cm, and the width of the fingerprint recognition portion 18 is not more than 50 μm. The number of fingerprint recognition electrodes 181 is approximately six hundred and the fingerprint recognition electrodes 181 are arranged in a strip in the present embodiment. With regards to the fingerprint recognition, the finger should be pressed against the fingerprint recognition portion 18 and slide in the same direction for the collection of sufficient fingerprint information in order to complete the recognition of the fingerprint. In other embodiments, the fingerprint recognition portion 18 may be other shapes and sizes. The fingerprint recognition electrodes 181 may be arranged in a matrix. A user can place a finger directly on the surface of the fingerprint recognition portion 18. Thus, the fingerprint recognition portion 18 can collect the information on a fingerprint to make an identification of the fingerprint.

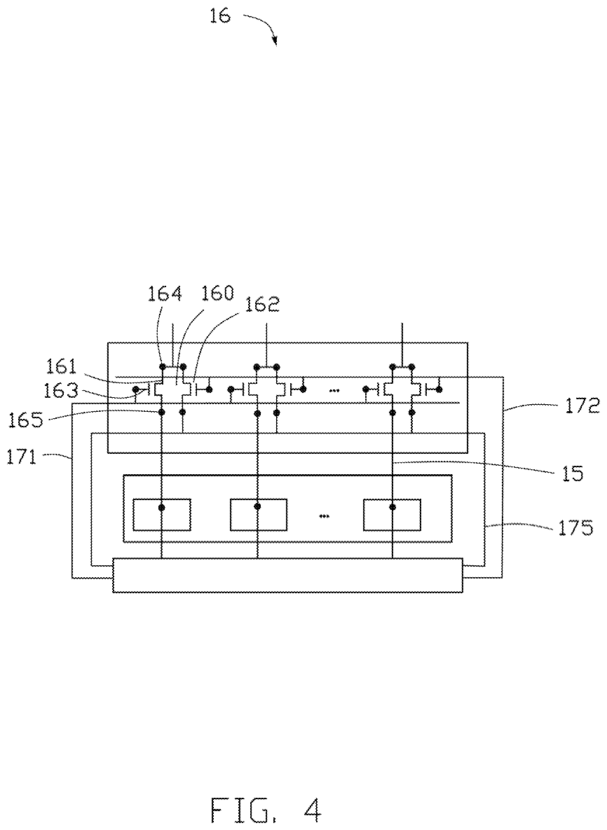

With reference to FIG. 4, the central processor 19 further includes a first signal control line 171, a second signal control line 172, and a common electrode line 175. The central processor 19 is electrically connected to the switch module 16 by the first signal control line 171, the second signal control line 172, and the common electrode line 175. The first signal control line 171 and the second signal control line 172 transmit a signal sent by the central processor 19 to the switch module 16. The switch module 16 can be off or on according to the signal. The common voltage signal output by the central processor 19 can be transmitted to the switch module 16 through the common electrode line 175.

With reference to FIG. 4, the switch module 16 includes a plurality of switching elements 160. At least one switching element 160 establishes an electrical connection between the touch electrodes 111 and one of the fingerprint recognition electrodes 181. Conversely, the touch electrodes 111 can be disconnected from the one of the fingerprint recognition electrodes 181. Each switching element 160 includes at least two TFTs. In one embodiment, the two TFTs include a first TFT 161 and a second TFT 162 connected in parallel. Each of the first TFT 161 and the second TFT 162 includes a source 164, a drain 165, and a gate 163. The gate 163 controls the connection and disconnection between the source 164 and the drain 165. The gate 163 of each first TFT 161 is electrically connected to the switch module 16 through the first signal control line 171. The gate 163 of each second TFT 162 is electrically connected to the switch module 16 through the second signal control line 172. In the present embodiment, the sources 164 of the first TFT 161 and the second TFT 162 are electrically connected to a touch electrode 111 through the trace layer 15. The drain 165 of the first TFT 161 is electrically connected to the fingerprint recognition electrodes 181 through the trace layer 15. The drain 165 of the second TFT 162 is electrically connected to the central processor 19 through the common electrode line 175. In other embodiments, the drains 165 of the first TFT 161 and the second TFT 162 are electrically connected to a touch electrode 111 through the trace layer 15. The source 164 of the first TFT 161 is electrically connected to a fingerprint recognition electrode 181 through the trace layer 15. The source 164 of the second TFT 162 is electrically connected to the central processor 19 through the common electrode line 175.

The touch display panel 10 can selectively operate at a touch-sensitive phase and a fingerprint-sensitive phase.

In the touch-sensitive phase, the central processor 19 controls the second TFT 162 to be off through the second signal control line 172. The central processor 19 controls the first TFT 161 to be on. The connection between the touch electrode 111 and the fingerprint recognition electrodes 181 is established. The touch electrode 111 outputs touch signal to the central processor 19 through the switching elements 160 and the fingerprint recognition electrodes 181 that are electrically interconnected. The central processor 19 transmits the common voltage to the display area AA through the same path. The central processor 19 senses the touch position on the touch display panel 10 and implements the touch operation. When the user touches the main touch portion 12, the self-capacitance of the touch electrode 111 is changed, and the respective capacitance values of the touched and the untouched electrodes 111 are significantly different. The central processor 19 determines the touch position by processing the electrical signals.

In the touch-sensitive phase, the fingerprint recognition portion 18 and the main touch portion 12 are connected in series. A capacitance can be changed between the fingerprint recognition electrodes 181 and the finger which is touching the fingerprint recognition portion 18. That is, the fingerprint recognition portion 18 may be accidentally touched at this stage, and a touch sensing signal is generated. Since the touch capacitance is proportional to the area of the touch electrode 111 and the fingerprint recognition electrodes 181. The area of the single fingerprint recognition electrode 181 is much smaller than the area of the single touch electrode 111. The change in capacitance of the touch recognition electrode 181 caused by such touch operation is much smaller than the change in capacitance of the touch electrode 111 caused by the touch operation. Therefore, in the touch-sensitive phase, the central processor 19 ignores the touch sensing signal generated by the fingerprint recognition portion 18 during the touch-sensitive phase, and only recognize touch signals generated by the main touch portion 12.

In the fingerprint identification stage, the central processor 19 controls the first TFT 161 to be off by the first signal control line 171, thereby disconnecting the touch electrode 111 from the fingerprint recognition electrodes 181. The central processor 19 controls the second TFT 162 to be on by the second signal control line 172. The touch electrode 111 receives the common voltage output by the central processor 19 through the second TFT 162 and the common electrode line 175. The touch electrode 111 has been disconnected from the fingerprint recognition electrodes 181. The fingerprint recognition electrodes 181 are electrically connected to the central processor 19. The fingerprint recognition electrodes 181 output the fingerprint signal to the central processor 19. The central processor 19 can use the signals from the fingerprint currently applied on the touch display panel 10 to implement fingerprint recognition.

Any electrical signals from the main touch portion 12 cannot be transmitted to the central processor 19, only the electrical signals from the fingerprint recognition portion 18 can be recognized and acted upon by the central processor 19.

The driving process of the touch display panel 10 further includes a display phase. The display phase, the touch-sensitive phase, and the fingerprint recognition phase are alternately performed during the driving process of the touch display panel 10. The length of the touch-sensitive phase is greater than the length of the fingerprint recognition phase. For example, in one frame (of 16.67 milliseconds), the total length of time in the touch-sensitive phase can be 2 milliseconds, the total length of time in the fingerprint recognition phase can be 1 millisecond, but the total length of time in the display phase can be 13.67 milliseconds.

In the present embodiment, the fingerprint recognition portion 18 is embedded in the touch display panel 10. The switch module 16 serves as a hub for controlling the fingerprint recognition portion 18 and the main touch portion 12, thereby improving the utilization ratio of the components and simplifying the structure. An additional fingerprint recognition module is not required, thus, the structure and the assembly process are simplified, and the cost is reduced.

### SECOND EMBODIMENT

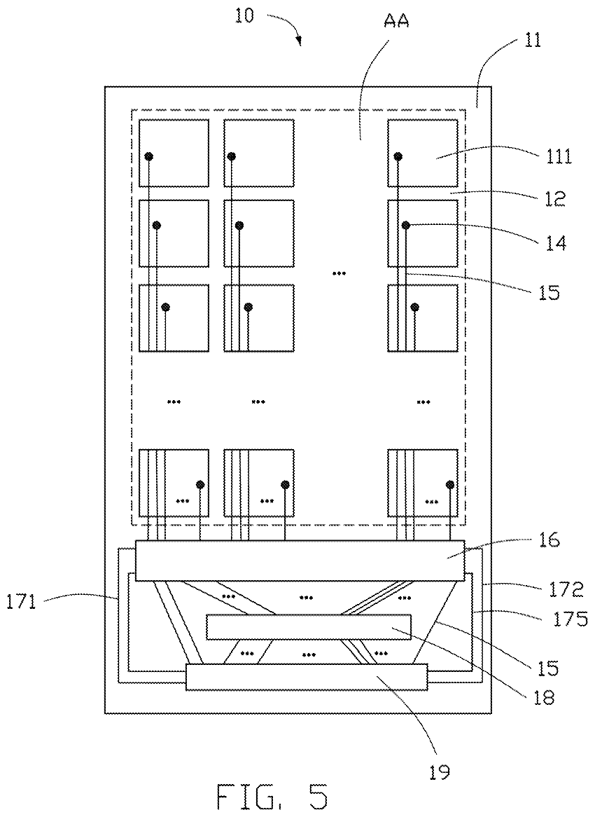

FIG. 5 shows a touch display panel 10 according to a second embodiment of the present disclosure. A portion of the touch electrodes 111 are electrically connected to the central processor 19 through the switching element 160 and the fingerprint recognition electrode 181. The remaining portion of the touch electrodes 111 are electrically connected to the central processor 19 directly through the switching elements 160. The touch electrodes 111 electrically connected to the central processor 19 through the switching elements 160 are symmetrically disposed on opposite sides of the fingerprint recognition unit 18. The fingerprint recognition unit 18 is located substantially at the center of an area beside the display area AA. The trace layer 15 positioned at outermost sides are directly and electrically connected to the central processor 19, and the remaining trace layer 15 are electrically connected to the central processor 19 through the fingerprint recognition electrodes 181.

In the present embodiment, some of the touch electrodes 111 are not directly connected to the central processor 19 through the fingerprint recognition electrodes 181, thus, the number of touch electrodes 111 is not limited to the number of identification electrodes 181. The number of touch electrodes 111 can thus be adjusted according to the desired precision of touch and touch ranges.

### THIRD EMBODIMENT

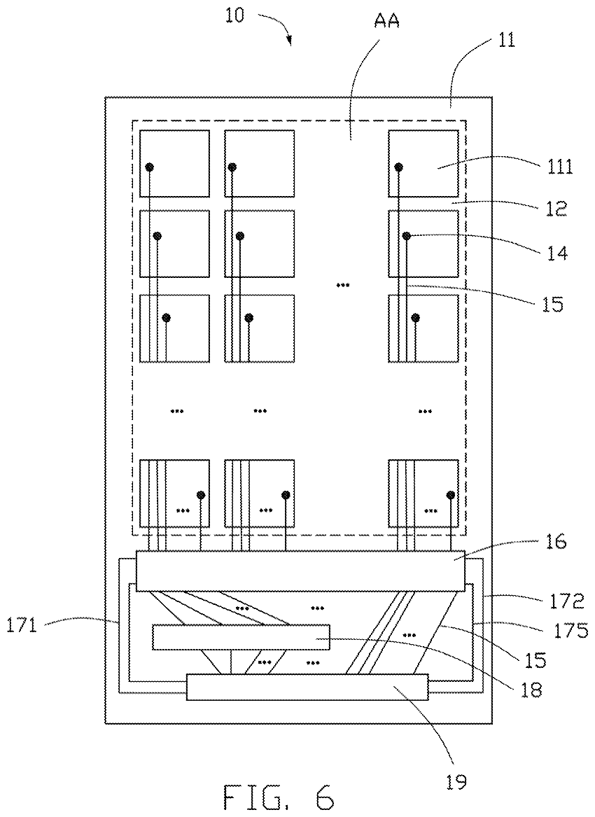

FIG. 6 is a schematic view of a touch display panel 10 according to a third embodiment of the present disclosure. A portion of the touch electrodes 111 are electrically connected to the central processor 19 via one switching element 160 and one fingerprint recognition electrode 181. The remaining portions of the touch electrodes 111 are directly electrically connected to the central processor 19 via a switching element 160. The touch electrodes 111 electrically connected to the central processor 19 through the switching elements 160 are symmetrically disposed on opposite sides of the fingerprint recognition unit 18. The fingerprint recognition unit 18 is located substantially at a position close to the edge of the display area AA. Among the trace layer 15 led out by the switch module 16, the trace layer 15 are directly and electrically connected to the central processor 19, the remaining trace layer 15 are connected to the central processor 19 through the fingerprint recognition electrodes 181.

In the present embodiment, some of the touch electrodes 111 are not directly connected to the central processor 19 through the plurality of fingerprint recognition electrodes 181, so that the number of the touch electrodes 111 could not be limited to the number of the identification electrodes 181, and the number of the touch electrodes 111 can be adjusted according to desired touch precisions and touch ranges.

### FOURTH EMBODIMENT

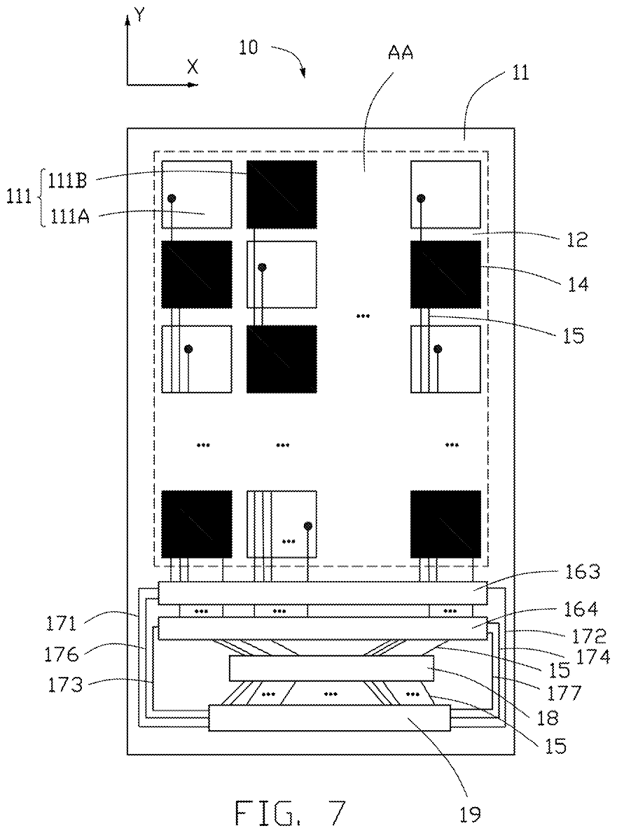

FIG. 7 is a schematic view of a touch display panel according to a fourth embodiment of the present disclosure. The difference between the fourth embodiment and the first embodiment is that, the touch electrode 111 further includes a plurality of first touch electrodes 111A and a plurality of second touch electrodes 111B, and the common electrode line further includes a first common electrode line 176 and the second common electrode line 177. The central processor 19 further includes a third signal control line 173 and a fourth signal control line 174. The plurality of first touch electrodes 111A and the plurality of second touch electrodes 111B are alternately disposed along a first direction X and alternately disposed along a second direction Y perpendicular to the first direction X. The switch module 16 includes a first switch module 163 and a second switch module 164. The first switch module 163 is spaced apart from the second switch module 164.

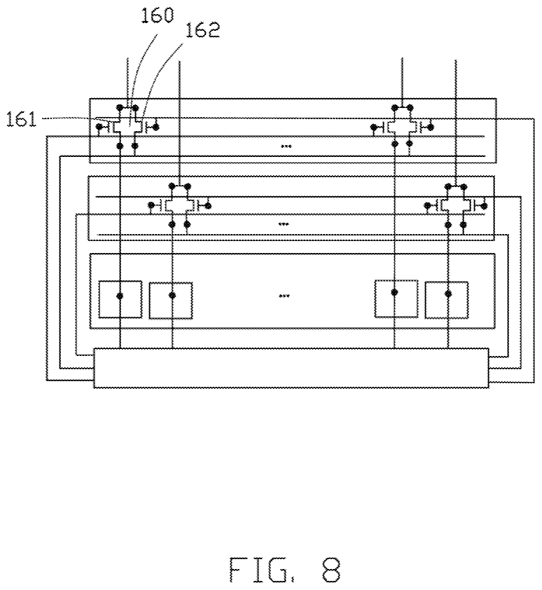

FIG. 8 is a partially enlarged schematic view of the touch display panel 10 of FIG. 7. The first switch module 163 is electrically connected to the central processor 19 through the first signal control line 171, the second signal control line 172, and the first common electrode line 176. The second switch module 164 is electrically connected to the central processor 19 through the third signal control line 173, the control line 174, and the second common electrode line 177. The plurality of first touch electrodes 111A are electrically connected to the central processor 19 through the first switch module 163 and the corresponding fingerprint recognition electrode 181. The plurality of second touch electrodes 111B are electrically connected to the central processor 19 through the second switch module 164 and the corresponding fingerprint recognition electrode 181.

In the present embodiment, the switch module 16 includes the first switch module 163 and the second switch module 164 that are independent of each other. The first switch module 163 and the second switch module 164 respectively control different touch sensing electrodes 111 and the electrodes 181 to be connected or disconnected. The main touch portion 12 can be connected to different switch module 16. When one of the first switch module 163 or the second switch module 164 is continuously disconnected due to a failure, at least another portion of the touch electrode 111 can be electrically connected to the processing unit 19 so that the touch function is maintained in a normal manner.

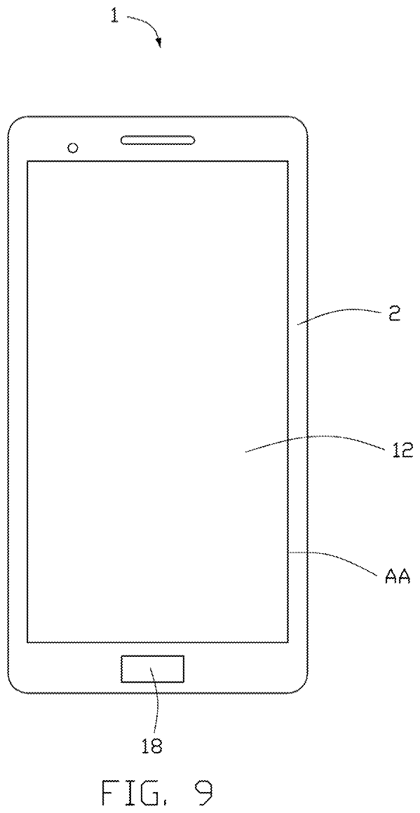

FIG. 9 is a schematic diagram of an electronic device 1 including the touch display panel 10. The electronic device 1 includes a main body 2, and the touch display panel 10 is disposed in the main body 2. The touch display panel 10 can be any of the touch display panels 10 described in the first embodiment to the fourth embodiment. With reference to FIG. 9, only the electronic device 1 is a mobile phone. In other embodiments, the electronic device 1 may also be a personal computer, a smart home appliance, an industrial controller, or the like.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A touch display panel, comprising:
a central processor;
a switch module;
a fingerprint recognition portion, wherein the fingerprint recognition portion is configured to sense a fingerprint signal, the fingerprint recognition portion comprises a plurality of fingerprint recognition electrodes; and
a main touch portion, wherein the main touch portion is configured to sense a touch position, and the main touch portion comprises a plurality of touch electrodes, and at least one of the plurality of touch electrodes is electrically connected to one of the plurality of fingerprint recognition electrodes through the switch module;
wherein the switch module is electrically connected to the central processor, the central processor further controls the switch module to establish an electrical connection between the at least one of the plurality of touch electrodes and the at least one of the plurality of fingerprint recognition electrodes or disconnect the at least one of the plurality of touch electrodes from the at least one of the plurality of fingerprint recognition electrodes.

2. The touch display panel of claim 1, wherein the switch module comprises a plurality of switching elements, each of the plurality of switching elements comprises two thin film transistors (TFTs) connected to each other in parallel, each of the TFTs comprises a source, a drain, and a gate, the at least one of the plurality of switching elements establishes an electrical connection between the at least one of the plurality of touch electrodes and the at least one of the plurality of fingerprint recognition electrodes or disconnect the at least one of the plurality of touch electrodes from the at least one of the plurality of fingerprint recognition electrodes.

3. The touch display panel of claim 2, wherein one of the plurality of touch electrodes is respectively connected to the sources of two TFTs of the plurality of switching elements, and the central processor is electrically connected to the drain of a TFT of one of the plurality of switching elements through a common electrode line, one of the plurality of fingerprint recognition electrodes is electrically connected to the drain of another TFT of the plurality of switching elements, the plurality of fingerprint recognition electrodes is electrically connected to the central processor, and the central processor is respectively connected to the gates of the two TFTs of the plurality of switching elements.

4. The touch display panel of claim 3, wherein the central processor further comprises a first signal control line and a second signal control line, the central processor is electrically connected to the gate of one TFT of the plurality of switching elements through the first signal control line, the central processor is electrically connected to the gate of another TFT of the plurality of switching elements through the second signal control line.

5. The touch display panel of claim 4, wherein the central processor controls the plurality of switching elements to be on or off, and when one of the two TFTs of the plurality of switching elements is turned on, the other one of the two TFTs is turned off.

6. The touch display panel of claim 1, wherein the touch electrode comprises a first touch electrode and a second touch electrode; the first touch electrode and the second touch electrode are alternately disposed along a first direction and alternately disposed along a second direction perpendicular to the first direction, the switch module comprises a first switch module and a second switch module, the central processor electrically connects to and controls the first switch module and the second switch module, each of the first touch electrodes, the first switch module, the plurality of fingerprint recognition electrodes and the central processor are electrically connected in series, each of the second touch, the second switch module, the plurality of fingerprint recognition electrodes and the central processor are electrically connected in series.

7. The touch display panel of claim 1, wherein the number of the plurality of touch electrodes is more than the number of the plurality of fingerprint recognition electrodes, and at least one of the plurality of touch electrodes is electrically connected to the central processor by the plurality of switching elements.

8. The touch display panel of claim 1, wherein when the switch module is turned off to disconnect the touch electrode from the plurality of fingerprint recognition electrodes, and the electrical signals of the plurality of fingerprint recognition electrodes are conducted to the central processor.

9. The touch display panel of claim 1, wherein when the switch module is turned on to establish the electrical connection between the touch electrode and the plurality of fingerprint recognition electrodes, the electrical signal of each of the plurality of touch electrodes is conducted to the central processor, the electrical signal of each of the plurality of fingerprint recognition electrodes is conducted to the central processor.

10. The touch display panel of claim 1, wherein an area of the fingerprint recognition portion is not larger than one hundredth of an area of the main touch portion.

11. The touch display panel of claim 1, wherein an area of each of the plurality of fingerprint recognition electrodes is not larger than one hundredth of an area of each of the plurality of touch electrodes.

12. The touch display panel of claim 1, wherein the touch display panel comprises a display area, the main touch portion is located in the display area, and the fingerprint recognition part and the switch module are located outside the display area.

13. The touch display panel of claim 1, wherein the touch display panel further comprises a TFT array substrate, and the main touch portion and the fingerprint recognition portion are both disposed on the TFT array substrate.

14. The touch display panel of claim 13, wherein the plurality of fingerprint recognition electrodes and the touch electrode are formed by a single photolithography process.

15. An electronic device comprising:
a main body; and
a touch display panel disposed in the main body, the touch display panel comprising:
a central processor;
a switch module;
a fingerprint recognition portion, wherein the fingerprint recognition portion is configured to sense a fingerprint signal, the fingerprint recognition portion comprises a plurality of fingerprint recognition electrodes; the plurality of fingerprint recognition electrodes is electrically connected to the central processor; and
a main touch portion, wherein the main touch portion is configured to sense a touch position, and the main touch portion comprises a plurality of touch electrodes, and at least one of the plurality of touch electrodes is electrically connected to one of the plurality of fingerprint recognition electrodes through the switch module;
wherein the central processor further controls the switch module to establish an electrical connection between the at least one of the plurality of touch electrodes and the at least one of the plurality of fingerprint recognition electrodes or disconnect the at least one of the plurality of touch electrodes and the at least one of the plurality of fingerprint recognition electrodes.

16. The electronic device of claim 15, wherein the switch module comprises a plurality of switching elements, each of the plurality of switching elements comprises two thin film transistors (TFTs) connected to each other in parallel, each of the TFTs comprises a source, a drain, and a gate, the at least one of the plurality of switching elements establishes an electrical connection between the at least one of the plurality of touch electrodes and the at least one of the plurality of fingerprint recognition electrodes or disconnect the at least one of the plurality of touch electrodes from the at least one of the plurality of fingerprint recognition electrodes.

17. The electronic device of claim 16, wherein one of the plurality of touch electrodes is respectively connected to the sources of two TFTs of the plurality of switching elements, and the central processor is electrically connected to the drain of a TFT of one of the plurality of switching elements through a common electrode line, one of the plurality of fingerprint recognition electrodes is electrically connected to the drain of another TFT of the plurality of switching elements, the plurality of fingerprint recognition electrodes is electrically connected to the central processor, and the central processor is respectively connected to the gates of the two TFTs of the plurality of switching elements.

18. The electronic device of claim 17, wherein the central processor further comprises a first signal control line and a second signal control line, the central processor is electrically connected to the gate of one TFT of the plurality of switching elements through the first signal control line, the central processor is electrically connected to the gate of another TFT of the plurality of switching elements through the second signal control line.

19. The electronic device of claim 18, wherein the central processor controls the plurality of switching elements to be on or off, and when one of the two TFTs of the plurality of switching elements is turned on, the other one of the two TFTs is turned off.

20. The electronic device of claim 15, wherein the touch electrode comprises a first touch electrode and a second touch electrode; the first touch electrode and the second touch electrode are alternately disposed along a first direction and alternately disposed along a second direction perpendicular to the first direction, the switch module comprises a first switch module and a second switch module, the central processor electrically connects to and controls the first switch module and the second switch module, each of the first touch electrodes, the first switch module, the plurality of fingerprint recognition electrodes and the central processor are electrically connected in series, each of the second touch, the second switch module, the plurality of fingerprint recognition electrodes and the central processor are electrically connected in series.
